(19) United States
(12) Patent Application Publication
(10) Pub. No.: US 2007/0153721 A1
(43) Pub. Date: Jul. 5, 2007

(54) Method of transferring session information between access nodes in a mobile communication network

(75) Inventors: Hai Le, Plano, TX (US); Prashanth Sharma, San Diego, CA (US); Biswajit Ghose, San Diego, CA (US)

Correspondence Address: COATS & BENNETT, PLLC, 1400 Crescent Green, Suite 300, Cary, NC, 27518, US

(73) Assignee: Telefonaktiebolaget LM

(21) Appl. No.: 11/323,741

(22) Filed: Dec. 30, 2005

(51) Int. Cl. H04Q 7/00

(52) U.S. Cl. 370/328; 370/395.52

(57) ABSTRACT

A method and apparatus for transferring session information from a source access node to a target access node reduces the delay in the delivery of packets for delay intolerant applications such as voice over IP. A protocol data table is stored in the target access node. The source access node sends the target access node a session configuration token that can be used to lookup session information in the protocol data table.

### BACKGROUND

The present invention relates generally to high speed packet data communications in CDMA systems and, more particularly, to a method of reducing packet latency and connection setup time during handovers in a mobile communication network having a distributed architecture.

High speed packet data networks are evolving toward a distributed architecture in which the radio base station, base station controller, and packet control function are integrated into a single node referred to herein as an access node (AN). This new distributed architecture is in contrast to existing hierarchical network architectures. With the new distributed architecture, reducing packet latency during handovers for applications such as voice-over-IP (VoIP) and push-to-talk (PTT) will be important considerations.

For high speed packet data services, forward link communications take place over a shared packet data channel. Packet data transmissions to different users are time multiplexed and transmitted at full power. Only one user receives transmissions from one AN at a time. Due to the complexity of coordinating packet data transmissions between sectors, soft handoff on the forward packet data channel is not used. Instead, a process known as sector selection or sector switching is used. The mobile station measures the instantaneous carrier-to-interference (C/I) ratio of the pilot signal received from each sector in its active set and requests service from the sector providing the strongest signal. As the mobile station moves away from the serving sector toward a non-serving sector, the signal strength from the serving sector will diminish while the signal strength from the non-serving sector will increase. When the signal strength from the non-serving sector exceeds the signal strength from the serving sector by a predetermined amount, the mobile station sends a signal to the network to switch sectors. In response to the mobile station signal, the newly-selected sector begins transmitting packets on the forward link to the mobile station.

Cell-switching occurs when the mobile station moves from a sector of one AN to a sector in a different AN. During cell-switching, the call context and session information may need to be transferred from the source AN to the target AN and the target AN needs to establish a radio packet (R-P) connection with the PDSN. The process of transferring the call context and setting up an R-P connection to the PDSN may introduce some delay in the delivery of packets to the mobile station. Many packet data applications are delay tolerant and the small delays due to cell switching may be acceptable for these applications. However, some packet data applications, such as voice-over IP, are delay intolerant and even small delays will negatively impact the quality of the connection. Therefore, it is desirable to minimize delays in delivering packet data for delay-sensitive applications when switching from a sector in one AN to a sector in a different AN.

### SUMMARY

The present invention relates to a method of transferring session information between access nodes in a mobile communication network. A protocol data table (PDT) is stored in each access node. The protocol data table stores valid combinations of AN-supported attribute values for different protocols. The same protocol data table is stored in memory at each AN. When the mobile station switches between sectors in different ANs, the source AN sends a session configuration token to the target AN. The target AN uses the session configuration token to look-up session information from the PDT. Thus, the session information embodied in the PDT does not need to be transferred from the source AN to the target AN. Instead, the source AN sends the session configuration token along with any session information not contained in the PDT.

### BRIEF DESCRIPTION OF THE DRAWINGS

FIG. 1 illustrates an exemplary mobile communication network.

FIG. 2 illustrates grouping of access networks to form subnets.

FIG. 3 illustrates logical elements in an exemplary access node for a mobile communication network.

FIG. 4 illustrates an exemplary procedure for establishing a packet data session.

FIG. 5 illustrates the format of an exemplary Universal Access Terminal Identifier.

FIG. 6 illustrates an exemplary structure for a Protocol Data Table

FIG. 7 illustrates an exemplary structure for an index table.

FIG. 8 illustrates an exemplary format for a bi-cast request

FIG. 9 is a call-flow diagram illustrating an exemplary fast cell-switching procedure.

FIG. 10 illustrates an exemplary mobile-initiated reactivation procedure for reactivating a dormant packet data session

### DETAILED DESCRIPTION

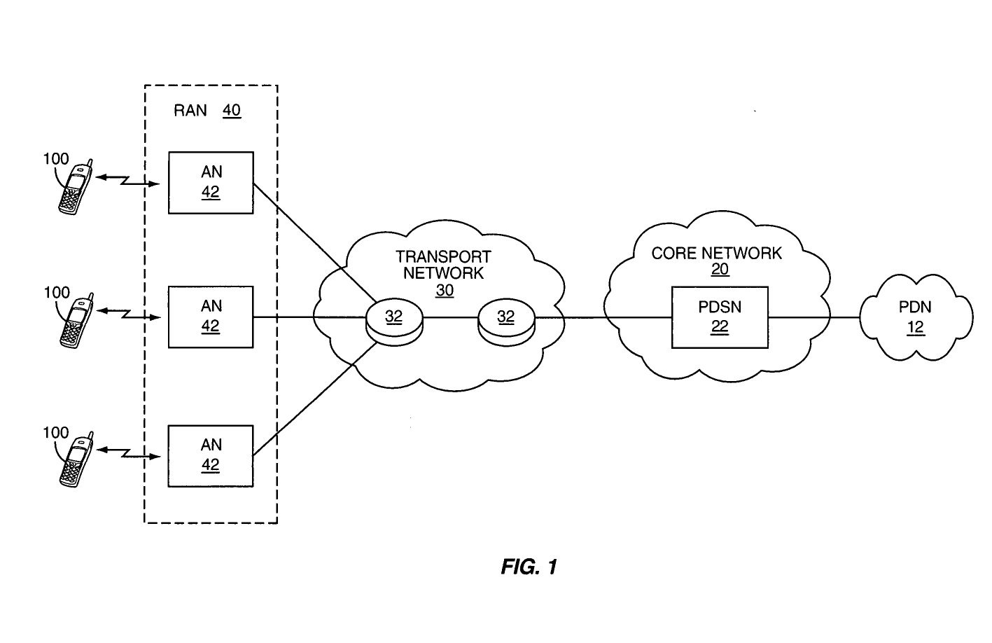

FIG. 1 illustrates an exemplary high-rate packet data (HRPD) network 10 according to one embodiment of the invention providing wireless packet data services for a plurality of mobile stations 100. Communication network 10 has a distributed rather than centralized architecture. Mobile communication network 10 comprises a packet-switched core network 20 including a Packet Data Serving Node (PDSN) 22, and a radio access network 40 comprising one or more access nodes (ANs) 42. An IP-based transport network 30 comprising one or more routers 32 connects the core network 20 with the RAN 40. The PDSN 22 connects to an external packet data network (PDN) 12, such as the Internet, and supports PPP connections to and from the mobile stations 100. The PDSN 22 adds and removes IP streams to and from the ANs 42 and routes packets between the external packet data network 12 and the ANs 42. The ANs 42 provide the connection between the mobile stations 100 and the core network 20. Each AN 42 corresponds to one packet zone 60. The ANs 42 may operate, for example, according to the Telecommunications Industry Association (TIA) standard TIA-856-A, which defines an air interface between the AN 42 and mobile stations 100. Those skilled in the art will appreciate that the present invention may also use in other air interface standards, such as TIA-2000 and the emerging Wideband CDMA standard.

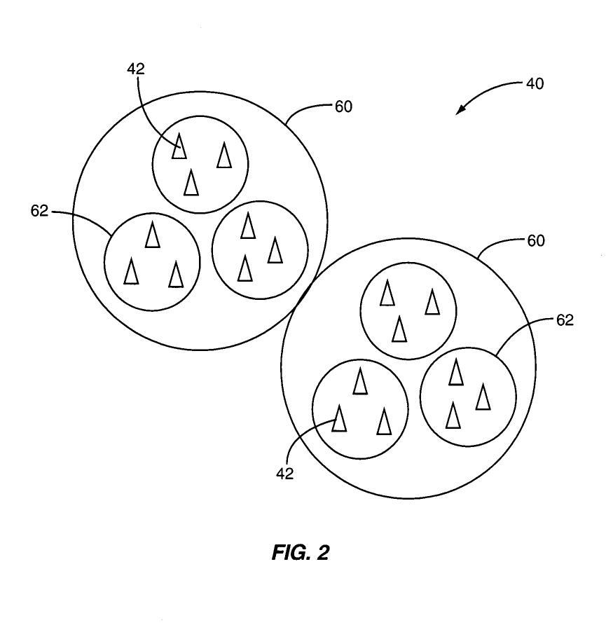

The ANs 42 are grouped to form subnets 60 as shown in FIG. 2. Each subnet 60 preferably covers a large area referred to herein as a multicast area. Each subnet 60 is further divided into smaller areas referred to herein as color code areas 62, which may encompass one or more ANs 42.

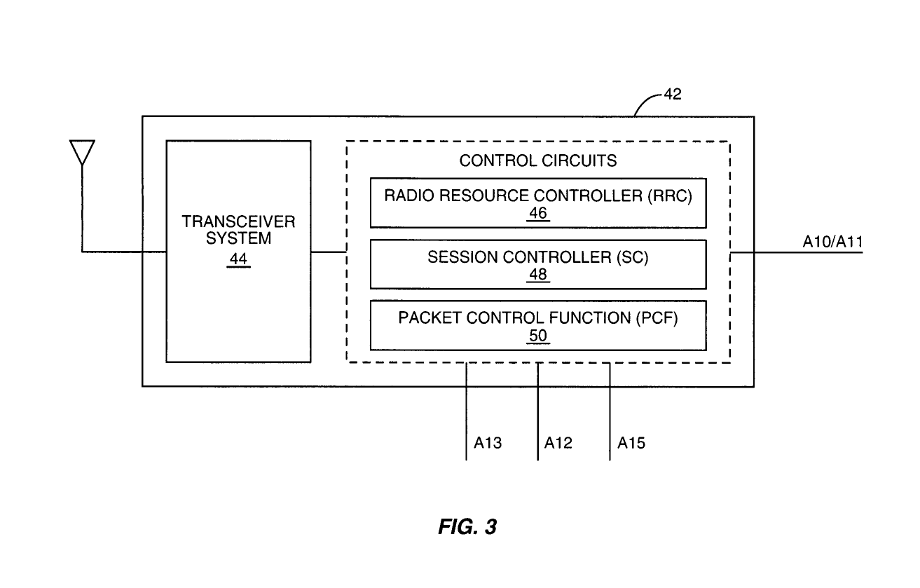

FIG. 3 illustrates the logical elements of an AN 42 in one exemplary embodiment. The exemplary AN 42 comprises a transceiver system 44 and associated control circuits, including a radio resource controller (RRC) 46, a session controller (SC) 48, and a Packet Control Function (PCF) 48 as defined in TIA-1878. The transceiver system 44 includes the radio equipment for communicating over the air interface with the mobile stations 100. The radio resource controller 46 manages radio and communication resources for the AN 42. The session controller 48 performs session control and mobility management (SC/MM) functions. The PCF 50 establishes, maintains, and terminates connections from the AN 42 to the PDSN 22.

Between the AN 42 and the PDSN 22, the user data travels over the A10 communication link. Generic Routing Encapsulation (GRE) is used to transport data over the A10 communication link. GRE is a well-known protocol for encapsulation of an arbitrary network layer protocol over another arbitrary network layer protocol. Signaling data travels between the AN 42 and PDSN 22 over the A11 link. Signaling between the ANs 42 travels over the A13 and A15 communication links. The A13 communication link is used to transfer session information between ANs 42 as hereinafter described. The A15 communication link is used for inter-AN paging. The AN 42 communicates with an AAA over the A12 communication link to authenticate mobile stations 100 attempting to access the network. The A10, A11, A12, A13 and A15 interfaces are defined in TIA-1878.

To transmit or receive packet data, the mobile station 100 establishes a packet data session with the PDSN 22. For each packet data session, the AN 42 opens a radio packet (R-P) connection (also called an A10 connection) with the PDSN 22 to establish a transmission path for user data between the PDSN 22 and AN 42 for packet data. The mobile station 100 negotiates session parameters with the AN 42 and establishes a traffic channel (TCH) with the AN 42 for forward and reverse traffic. The session parameters include the protocols used for communication between the AN 42 and mobile station 100, and the protocol settings. The session parameters are stored by the session controller 48 at the AN 42.

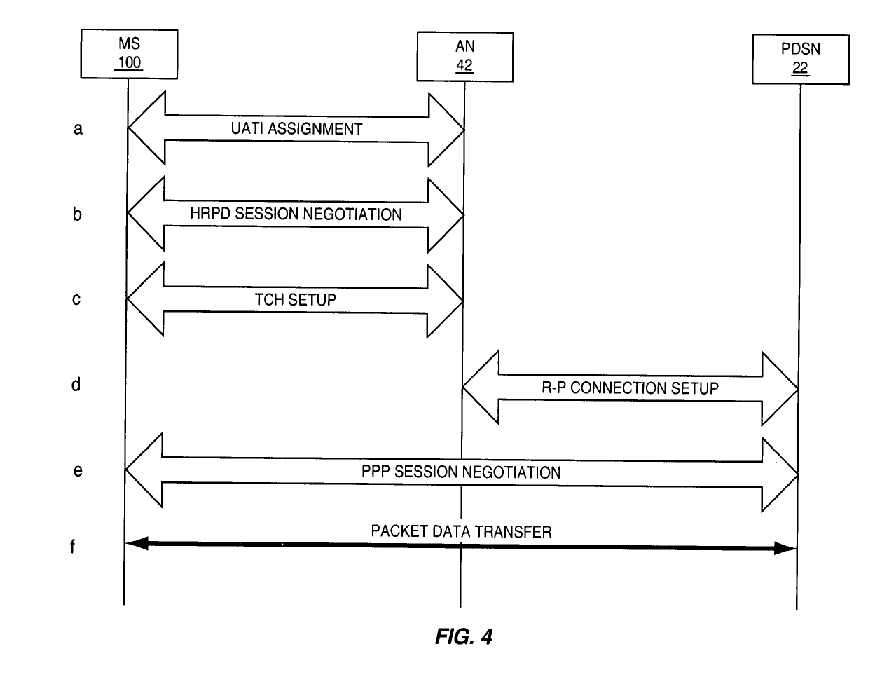

FIG. 4 illustrates an exemplary mobile initiated session establishment procedure for establishing a packet data session. The mobile station 100 requests allocation of a Unicast Access Terminal Identifier (UATI) by the AN 42 (step a). The allocation of the UATI may be performed by the session controller 48. The UATI uniquely identifies the mobile station 100 to the AN 42. The UATI may be allocated from a UATI pool assigned exclusively to the AN 42. After the UATI is allocated, the mobile station 100 and AN 42 establish an HRPD session (step b). An HRPD session is a shared state between the AN 42 and mobile station 100. During the HRPD session establishment procedure, the mobile station 100 and AN 42 negotiate the protocols and protocol configurations that will be used for communications over the air interface. The HRPD session information is stored and maintained by the session controller 42. The mobile station 100 and AN 42 then setup a traffic channel (step c).

The AN 42 also establishes a radio packet (R-P) connection with the PDSN 22. In one exemplary embodiment, the PDSN 22 connects with the PCF 48 in the AN 42 by setting up a GRE tunnel over the A10 communication link (step d). The mobile station 100 establishes a packet data session with the PDSN 22 (step e). A packet data session is an instance of a packet data service. In one embodiment, the mobile station 100 establishes an end-to-end connection with the PDSN 22 using, for example, the Point-To-Point Protocol (PPP). After establishing a PPP session, the mobile station 100 can transmit and receive packet data (step f).

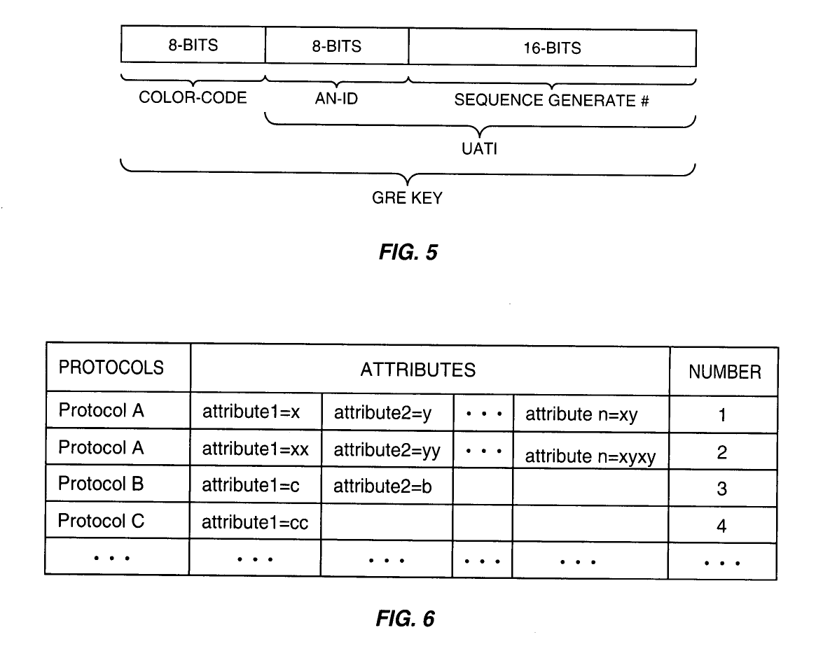

In one exemplary embodiment, The UATIs are divided among the ANs 42 in a subnet 60 such that each AN 42 has its own pool of UATIs. FIG. 5 illustrates the structure of the UATI according to one exemplary embodiment. As seen in FIG. 5, the UATI comprises 24 bits. The 16 least significant bits of the UATI are assigned to the mobile station 100 during a call set-up by the serving AN 42 and uniquely identify the mobile station 100 to the serving AN 42. The 8 most significant bits uniquely identify an AN 42 within a given color code area 62. A color code prefix may be appended to the UATI to generate a 32-bit key that can be used to identify a packet data session. The 8-bit color code prefix uniquely identifies a color code area 62 in a subnet 60. The 32-bit key can be used, for example, in GRE packets transmitted between an AN 42 and the PDSN 22 as hereinafter described.

In HRPD systems, according to the TIA-856A standard, packet data is transmitted on the forward link over a shared packet data channel called the Forward Traffic Channel. Packet data transmissions to different users are time multiplexed and transmitted at full power. Only one user receives transmissions from the access network at a time. Due to the complexity of coordinating packet data transmissions between sectors, soft handoff for the forward packet data channel is not used. Instead, a process known as sector selection or sector switching is used. The mobile station 100 monitors the signal power from all sectors in its active set and selects the sector that provides the strongest signal as the serving sector. As the mobile station 100 moves away from the serving sector toward a non-serving sector belonging to a different AN 42, the signal strength from the serving sector will diminish while the signal strength from the non-serving sector will increase. When the signal strength from a candidate sector in the mobile station's active set exceeds the signal strength from the serving sector by a predetermined amount, the mobile station sends a signal to the network 10 to switch sectors. This process is known as sector switching or cell switching when the sectors belong to different ANs 42. In HRPD systems, according to the TIA-856A standard, the mobile station 100 indicates the selected sector by the Walsh cover applied to its data rate requests transmitted on the Data Rate Control (DRC) channel. When the mobile station 100 signals a sector change, the sector selected by the mobile station 100, referred to herein as the target sector, becomes the serving sector and begins transmitting packets on the forward link to the mobile station 100. The previous serving sector, referred to herein as the source sector, stops transmitting packets.

When the target sector belongs to a different AN 42, the call context and session information need to be transferred to the target AN 42. Additionally, the target AN 42 needs to establish a radio packet (R-P) connection with the PDSN 22. The process of transferring the session information and setting up an R-P connection to the PDSN 22 may introduce some delay in the delivery of packets to the mobile station 100. Many packet data applications are delay tolerant and the small delays due to cell switching may be acceptable for these applications. However, some packet data applications, such as voice-over IP, are delay intolerant and even small delays will negatively impact the perceived quality of the connection. Therefore, it is desirable to minimize delays in delivering packet data for these delay-sensitive applications when switching from a sector in one AN 42 to a sector in a different AN 42.

The present invention reduces packet latency for applications such as voice-over-IP (VoIP) by reducing the time needed to transfer session information from a source AN 42 to a target AN 42, and by reducing the time needed to set-up an A10 connection between the target AN 42 and the PDSN 22. The reduction in transfer time for transferring the session information is accomplished by using a Protocol Data Table (PDT). The use of the PDT reduces the amount of session information that needs to be transferred between ANs 42 during cell switching and consequently the transfer time. The reduction in set up time for the A10 connection is achieved by sending a bi-cast request from the source AN 42 over the existing A10 connection to the PDSN 22 to notify the PDSN 22 when the mobile station 100 is switching between sectors in different ANs 42. The PDSN 22 can then establish an A10 connection with the target AN 42 without the need for A11 signaling and bi-cast packets for the mobile station 100 to both the source AN 42 and target AN 42 for a period of time specified in the bi-cast request. Each of these techniques is described in greater detail below.

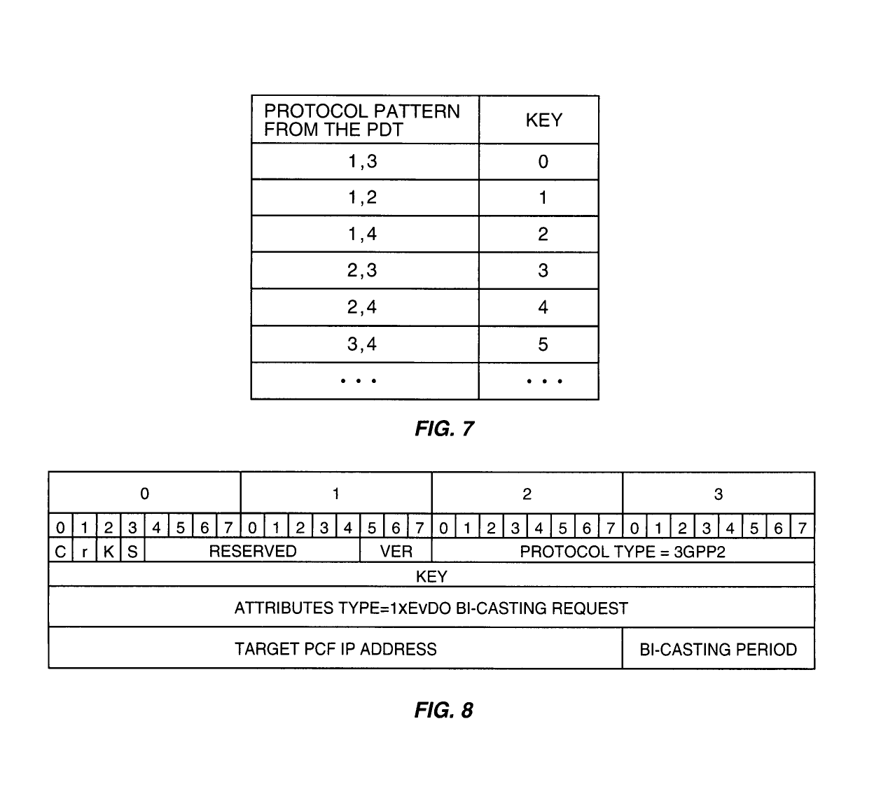

FIG. 6 illustrates the structure of an exemplary PDT. The PDT is used to store protocol configuration information to facilitate transfer of session information between ANs 42. The PDT is stored in memory at each AN 42. The same PDT is stored at each AN 42. The PDT stores different protocol configurations that are supported by the ANs 42. Each row of the PDT relates to a specific protocol and sets the values for one or more attributes of the protocol. There may be multiple rows in the PDT for the same protocol with a different set of attribute values in each row. Each row is assigned a unique configuration number. All valid protocol combinations are assigned a unique index key, which is stored in a separate index table shown in FIG. 7. The index key is used to look-up protocol configuration information from the PDT. Thus, the information stored in the PDT does not need to be transferred to the target ANC; only the index key needs to be transferred.

At the end of session negotiation, the mobile station 100 is assigned a token by the AN, referred to in the IS-856A standard as the Session Configuration Token, to be used in subsequent access channel messages. The Session Configuration Token is set equal to one of the unique keys in the index table to indicate the HRPD session configuration of the mobile station 100. Because all ANs 42 have the same PDT, the AN 42 can use the Session Configuration Token to look-up configuration information for the mobile station 100 by comparing the session configuration token to the index keys stored in the index table. If a matching key is found, the protocol configuration numbers associated with the index key are used to look-up attribute values for the corresponding protocols from the PDT. The use of the PDT greatly reduces the amount of session information that needs to be transferred between ANs 42 during cell switching.

FIG. 8 illustrates an exemplary bi-cast request according to one embodiment of the present invention that is used to facilitate A10 connection set-up. As noted above, data packets are encapsulated in GRE packets for transmission over the A10 communication link to the PDSN 22. The bi-cast request is a specialized GRE packet transmitted from the source AN 42 that serves as a request to the PDSN 22 to bi-cast GRE packets containing data for the mobile station 100 to both the source AN 42 and the target AN 42 for a specified period of time, after which the PDSN 22 stops forwarding GRE packets to the source AN 42 and continues forwarding GRE packets to the target AN 42.

The bi-cast request in the exemplary embodiment includes the following information elements (IEs): a Protocol Type IE, a GRE Key IE, an Attribute Type IE, a Target Address IE, and a Bi-Casting Period IE. The Protocol Type IE specifies the protocol type of the encapsulated data. In the exemplary embodiment, the Protocol Type is set to indicate 3GPP2. The GRE Key IE contains a unique 32-bit key referred to herein as the GRE key that uniquely identifies a packet data session to the PDSN 22. In the exemplary embodiment, the AN 42 uses the UATI assigned to the mobile station 100 plus an 8-bit color code as the GRE key as shown in FIG. 5. The Attribute Type IE specifies the type of message. The Target Address specifies the address of the target AN 42. The Bi-Casting Period IE specifies the period during which GRE packets are to be bi-cast to the source AN 42 and target AN 42. When the PDSN 22 receives this unique GRE packet, it immediately begins bi-casting packets for the duration of the bi-cast period specified in the bi-cast request. When the target AN 42 receives packets containing the GRE key from the PDSN 22, the target AN 42 can identify the mobile station 100 for whom the packets are intended based on the GRE key.

The source AN 42 transmits the bi-cast request over the A10 communication link from the source AN 42 to the PDSN 22 when the mobile station 100 indicates that it is switching cells. Prior to switching sectors, a mobile station 100 gives an early indication of its desire to switch sectors by sending an indication to the source AN 42 over the data source channel (DSC). When the source AN 42 receives the DSC indication from the mobile station 100 indicating that the mobile station 100 is about to switch cells to a different target AN, the source AN 42 sends the bi-cast request over the A10 link to the PDSN 22.

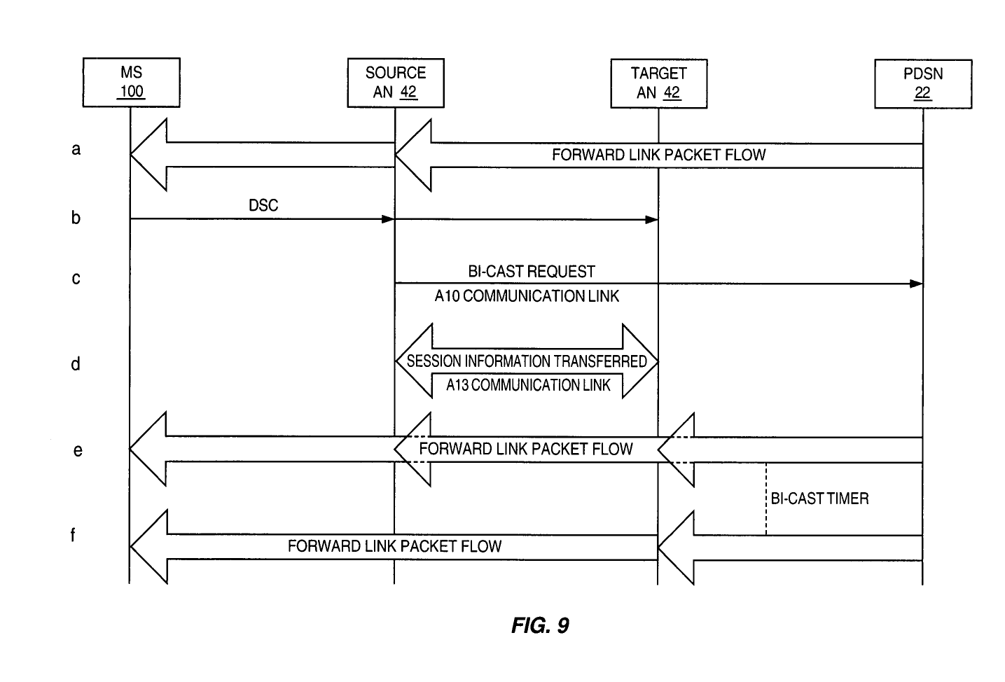

FIG. 9 is a call flow diagram illustrating an exemplary procedure for cell-switching using the bi-cast request. The mobile station 100 is engaged in an active packet data session (step a). The mobile station 100 sends a DSC indication indicating that the target AN 42 has been selected as the new forward link serving sector (step b). Responsive to the DSC indication, the source AN 42 sends a bi-cast request to the PDSN 22 over the A10 communication link (step c). The source AN 42 transfers session information including the session configuration token and other session information not contained in the PDT, such as the RLP sequence number and MN-ID (step d). The transfer of session information may be initiated by either the source AN 42 or target AN 42 responsive to the DSC indication from the mobile station 100. Based on the session information token, the target AN 42 can determine session parameters for the session from the PDT as previously described. The use of the session configuration token and PDT reduces the amount of session information that needs to be transferred from the source AN to the target AN. After receiving the bi-cast request from the source AN 42, the PDSN 22 begins bi-casting packets to both the source AN 42 and target AN 42 and sets a timer (step e). When the target AN 42 receives the packets, the target AN 42 can identify the mobile station 100 for whom the packets are intended by comparing the GRE key of the received packets with the UATI of the mobile station 100. The PDSN 22 continues bi-casting until the timer expires. When the bi-cast timer expires, the PDSN 22 stops sending packets to the source AN 42 and continues sending packets to the target AN 42 (step f).

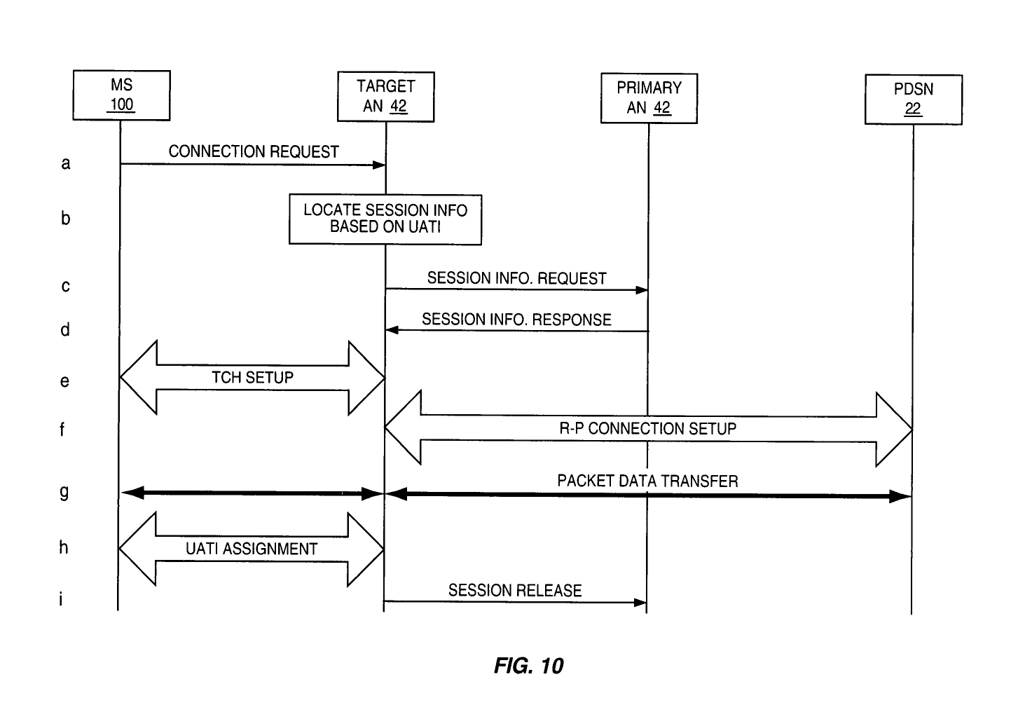

FIG. 10 illustrates an exemplary mobile-initiated reactivation procedure for reactivating a dormant packet data session according to one embodiment of the invention. When the packet data session is dormant, the mobile station 100 does not have a connection with an AN 42. When the mobile station 100 needs to send data, the mobile station 100 sends a connection request to a target AN to establish a connection with the target AN (step a). The connection request is sent over the reverse access channel. The connection request includes the UATI of the mobile station 100. Based on the UATI, the target AN determines the identity of the AN 42 where the session information for the mobile station 100 is stored (step b). The target AN sends a request for the session information to the AN 42 storing the session information (step c), which in this example is the source AN. The source AN sends the session information to the target AN using the PDT as described above to reduce the amount of information that needs to be transferred (step d). After the session information is transferred to the target AN, the target AN establishes an HRPD connection with the mobile station (step e). The target AN also establishes an R-P connection with the PDSN 22 to provide a transmission path for the packet data (step f). After establishing the HRPD and R-P connections, the mobile station 100 can send and receive packet data (step g). The target AN may reassign a UATI selected from its own UATI pool, since the originally-assigned UATI will not correctly identify the AN storing the session information (step h). After a new UATI is assigned, the target AN may send a session release message to the source AN and the source AN can delete the session information (step i). It should be noted that the UATI assignment and session release steps will not be performed if the session control is not transferred to the target AN. The source AN can delete the session information after it receives the session release message.

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A method of transferring session information for a communication session between two access nodes in a mobile communication network, said method comprising:
storing a protocol data table in memory at a target access node, said protocol data table including protocol configuration data for one or more protocol configurations;
receiving a message including a session configuration token at the target access node from a source access node; and
retrieving protocol configuration information from said protocol data table using said session configuration token.

2. The method of claim 1 wherein said protocol data table includes at least two protocol configurations for the same protocol.

3. The method of claim 1 wherein the protocol data table includes protocol configurations for at least two different protocols.

4. The method of claim 1 wherein retrieving protocol configuration information from said protocol data table using said session configuration token comprises:
assigning a configuration identifier to each protocol configuration stored in the protocol data table;
mapping the session configuration token to one or more configuration identifiers; and
using the configuration identifier as an index to said protocol data table to retrieve said protocol configuration data from said protocol data table.

5. The method of claim 4 further comprising storing said configuration identifiers in a mapping table that associates said configuration identifiers with specific protocol configurations stored in the protocol data table.

6. The method of claim 1 wherein the message is received from a mobile station over an access channel.

7. An access node for a mobile communication network comprising:
memory for storing a protocol data table including protocol configuration data for one or more protocol configurations; and
a controller responsive to receipt of a session configuration token to retrieve protocol configuration information from said protocol data table using said session configuration token as an index.

8. The access node of claim 7 wherein said protocol data table includes at least two protocol configurations for the same protocol.

9. The access node of claim 7 wherein the protocol data table includes protocol configurations for at least two different protocols.

10. The access node of claim 7 wherein the controller retrieves protocol configuration information from said look-up table by:
mapping the session configuration token to one or more configuration identifiers; and
using the configuration identifiers as an index to said protocol data table to retrieve said protocol configuration data from said protocol data table.

11. The access node of claim 10 wherein said memory is further used for storing a mapping table that associates said configuration identifiers with specific protocol configurations stored in the protocol data table.

12. The access node of claim 7 wherein the message is received from a mobile station over an access channel.
